(19) United States
(12) Patent Application Publication
(10) Pub. No.: US 2014/0056044 A1
(43) Pub. Date: Feb. 27, 2014

(54) PHOTOVOLTAIC INVERTER AND A CONTROL METHOD THEREOF

(71) Applicants: Raydium Semiconductor Corporation, Hsinchu City (TW); National Cheng Kung University, Tainan City (TW)

(72) Inventors: Hong-Tzer YANG, Tainan City (TW); Ya-Chin CHENG, Tainan City (TW)

(21) Appl. No.: 13/894,746

(22) Filed: May 15, 2013

(30) Foreign Application Priority Data
Aug. 22, 2012 (TW) 101130443

(51) Int. Cl. H02M 7/537

(52) U.S. Cl. CPC H02M 7/537
USPC 363/97; 363/131

(57) ABSTRACT

A photovoltaic inverter includes an input circuit, a decoupling circuit and an output circuit. The input circuit has a DC input port, an input capacitor, a magnetizing inductor, a first unidirectional element and a first switch. The magnetizing inductor forms first and second connection nodes. The decoupling circuit has a second unidirectional element, a second switch, a third switch, a third unidirectional element and a decoupling capacitor. The second unidirectional element and the second switch are connected in series at a first node. The third switch and the third unidirectional element are connected in series at a second node. The output circuit has a transformer, a fourth unidirectional element, a fourth switch, an output capacitor, a fifth switch, a fifth unidirectional element, an output inductor and an AC output port. The transformer includes an input port and first and second output ports. A control method of the inverter is disclosed.

### BACKGROUND OF THE INVENTION

1. Field of the Invention

The present invention generally relates to a photovoltaic inverter and a control method thereof and, more particularly, to a photovoltaic inverter with electrical decoupling capability and a control method thereof.

2. Description of the Related Art

Green power has gradually become an important issue in industrial and academic circles due to the climate change and the trend in environmental protection. Green power includes solar power, wind energy, ocean energy, geothermal energy, etc. In photovoltaic generation, a photovoltaic system is used to convert solar power into direct current, which is then converted into alternating current via a photovoltaic inverter to be supplied to a terminal power system.

However, the output power of the photovoltaic inverter (such as a flyback inverter) has a frequency that is twice as high as the frequency of the utility, resulting in a large ripple current at the input end of the photovoltaic inverter. As a result, the maximum power point of the photovoltaic system and the quality of the output current are affected.

To solve this problem, Young-Hyok Ji et al. disclosed a paper entitled “Dual Mode Switching Strategy of Flyback Inverter for Photovoltaic AC Modules” in the International Power Electronics Conference held in 2010. In this paper, a solar panel is electrically connected to an input end of a photovoltaic inverter. The input end of the photovoltaic inverter is connected to an input capacitor in parallel, so as to reduce the ripple current at the input end of the photovoltaic inverter. The input capacitor should have a large capacity (such as an electrolytic capacitor with the capacitance of 13.2 mF) in order to minimize the undesired effect resulted from the ripple current. However, since the photovoltaic inverter often operates in a high temperature environment where the electrolytic capacitor is not suitable, the service life of the photovoltaic inverter is easily shortened and the reliability of the photovoltaic inverter is lowered. The photovoltaic inverter also has another disadvantage that the electrolytic capacitor occupies a large space. To solve this problem, a photovoltaic inverter with electrical decoupling capability was developed.

Referring to FIG. 1, Yaow-Ming Chen et al. disclosed a conventional photovoltaic inverter 9 in a paper entitled “Three-Port Flyback-Type Single-Phase Micro-Inverter with Active Power Decoupling Circuit” in the 2011 IEEE conference. The photovoltaic inverter 9 includes an input port 91 and two output ports 92a, 92b. The input port 91 is connected to an input capacitor 93 and a solar panel P in parallel. An unfolder circuit 94 is arranged between the output port 92a and an AC output port A. The unfolder circuit 94 is adapted to control the output signal of the AC output port A. The output port 92b is electrically connected to a decoupling circuit (APDC) 95 so that the required capacitance of the input capacitor 93 can be reduced to as low as 40 μF.

However, the turn ratio of the photovoltaic inverter 9 must be increased when the input voltage of the photovoltaic inverter 9 is increased from 30 Vrms to 110 Vrms. Consequently, the voltage stresses of the electronic switches are forcibly increased, resulting in an undesired effect. Furthermore, both the unfolder circuit 94 and the decoupling circuit 95 are implemented with four electronic switches (such as MOSFET), therefore the total number of electronic switches of the photovoltaic inverter 9 is large (10 in total), increasing the manufacturing cost and raising the issue of heat dissipation.

In conclusion, the photovoltaic inverter 9 is criticized for larger quantity of electronic switches used, as well as for increased voltage stresses of the electronic switches. Therefore, the use of the photovoltaic inverter 9 is limited and drawback is caused with inconvenience. In light of this, it is necessary to improve the conventional photovoltaic inverter 9.

### SUMMARY OF THE INVENTION

It is therefore the objective of this invention to provide a photovoltaic inverter and a control method thereof in which the circuit configuration of the photovoltaic inverter is improved to reduce the number of electronic switches required.

In an embodiment, a photovoltaic inverter is disclosed. The photovoltaic inverter comprises an input circuit, a decoupling circuit and an output circuit. The input circuit has a DC input port, an input capacitor, a magnetizing inductor, a first unidirectional element and a first switch. The DC input port is connected to the input capacitor in parallel. The input capacitor is connected to the magnetizing inductor, the first unidirectional element and the first switch in series. The magnetizing inductor has two ends forming a first connection node and a second connection node. The decoupling circuit has a second unidirectional element, a second switch, a third switch, a third unidirectional element and a decoupling capacitor. The second unidirectional element and the second switch are connected in series at a first node and between the first connection node and the second connection node. The third switch and the third unidirectional element a connected in series at a second node and between the first connection node and the second connection node. The decoupling capacitor is connected between the first and second nodes. The output circuit has a transformer, a fourth unidirectional element, a fourth switch, an output capacitor, a fifth switch, a fifth unidirectional element, an output inductor and an AC output port. The transformer comprises an input port, a first output port and a second output port. The input port is electrically connected to the magnetizing inductor in parallel. The first output port is electrically connected to the second output port in series. The first output port is electrically connected to the fourth unidirectional element, the fourth switch and the output capacitor in series. The second output port is electrically connected to the output capacitor, the fifth switch and the fifth unidirectional element in series. The output capacitor is electrically connected to the output inductor and the AC output port in series.

In a preferred form shown, the second unidirectional element comprises an anode electrically connected to the second connection node and an input end of the third switch. The second unidirectional element further comprises a cathode electrically connected to an input end of the second switch and a first end of the decoupling capacitor. The third unidirectional element comprises an anode electrically connected to a second end of the decoupling capacitor and an output end of the third switch. The third unidirectional element further comprises a cathode electrically connected to an output end of the second switch and the first connection node.

In the preferred form shown, the decoupling capacitor is a film capacitor of which the capacitance is 60 μF.

In the preferred form shown, the input port of the transformer comprises first and second ends electrically connected to the first and second connection nodes, respectively. Both the first and second output ports comprise first and second ends. The first ends of the first and second output ports are electrically connected together as a common node. The second end of the first output port is electrically connected to an anode of the fourth unidirectional element. The fourth unidirectional element further comprises a cathode electrically connected to an input end of the fourth switch. The fourth switch further comprises an output end electrically connected to an input end of the fifth switch to form a linking node. The fifth switch comprises an output end electrically connected to an anode of the fifth unidirectional element. The fifth unidirectional element further comprises a cathode electrically connected to the second end of the second output port. The output capacitor, comprises first and second ends that are electrically connected to the common node and the linking node, respectively. The output inductor and the AC output port are electrically connected in series between the first and second ends of the output capacitor.

In the preferred form shown, the DC input port comprises first and second ends electrically connected to first and second ends of the input capacitor. The first end of the input capacitor is electrically connected to the first connection node. The second connection node is electrically connected to an anode of the first unidirectional element. The first unidirectional element further comprises a cathode electrically connected to an input end of the first switch. The first switch further comprises an output end electrically connected to the second end of the input capacitor.

In the preferred form shown, each of the first, second, third, fourth and fifth switches includes a transistor.

In the preferred form shown, each of the first, second, third, fourth and fifth unidirectional elements includes a diode.

In the preferred form shown, the photovoltaic inverter further comprises a control device having a first output end, a second output end, a third output end, a fourth output end and a fifth output end. The first output end is electrically connected to a control end of the first switch. The second output end is electrically connected to a control end of the second switch. The third output end is electrically connected to a control end of the third switch. The fourth output end is electrically connected to a control end of the fourth switch. The fifth output end is electrically connected to a control end of the fifth switch.

In the preferred embodiment, a control method of the photovoltaic inverter is disclosed. In the method, a control device is used to retrieve information regarding a magnitude of an excitation current flowing through the magnetizing inductor, a magnitude of a decoupling current flowing in the decoupling circuit, and a magnitude of an output voltage of a terminal power system. The retrieved information is used to generate a first control signal, a second control signal, a third control signal, a fourth control signal and a fifth control signal for controlling the ON/OFF function of the first switch, the second switch, the third switch, the fourth switch and the fifth switch. The control method comprises an input step, a decoupling step and a conversion step. The input step is adapted to turn on the first switch and to turn off the second switch, the third switch, the fourth switch and the fifth switch, so as to allow the magnetizing inductor to store energy delivered from the DC input port. The decoupling step is adapted to turn off the first switch when the excitation current has reached an excitation threshold. The decoupling step is further adapted to turn off the second switch and the third switch when the magnitude of the decoupling current is larger than a decoupling threshold, so as to allow the magnetizing inductor to discharge energy to the decoupling capacitor. The decoupling step is further adapted to turn on the second switch and the third switch when the magnitude of the decoupling current is smaller than the decoupling threshold, so as to allow the decoupling capacitor to discharge energy to the magnetizing inductor. The conversion step is adapted to turn on the fourth switch and to turn off the fifth switch if the output voltage of the terminal power system is in a positive cycle when the decoupling current is equal to the decoupling threshold, so as to allow the first output port to discharge energy to the output capacitor. The conversion step is further adapted to turn on the fifth switch and to turn off the fourth switch if the output voltage of the terminal power system is in a negative cycle, so as to allow the second output port to discharge energy to the output capacitor. Energy is discharged from the output capacitor to the AC output port via the output inductor when the fourth switch or the fifth switch is turned off, thereby delivering AC power to the terminal power system.

In the preferred form shown, the excitation threshold is 33.71 A.

In the preferred form shown, the decoupling threshold is an envelope of the output voltage of the terminal power system.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a circuit diagram of a conventional photovoltaic inverter.

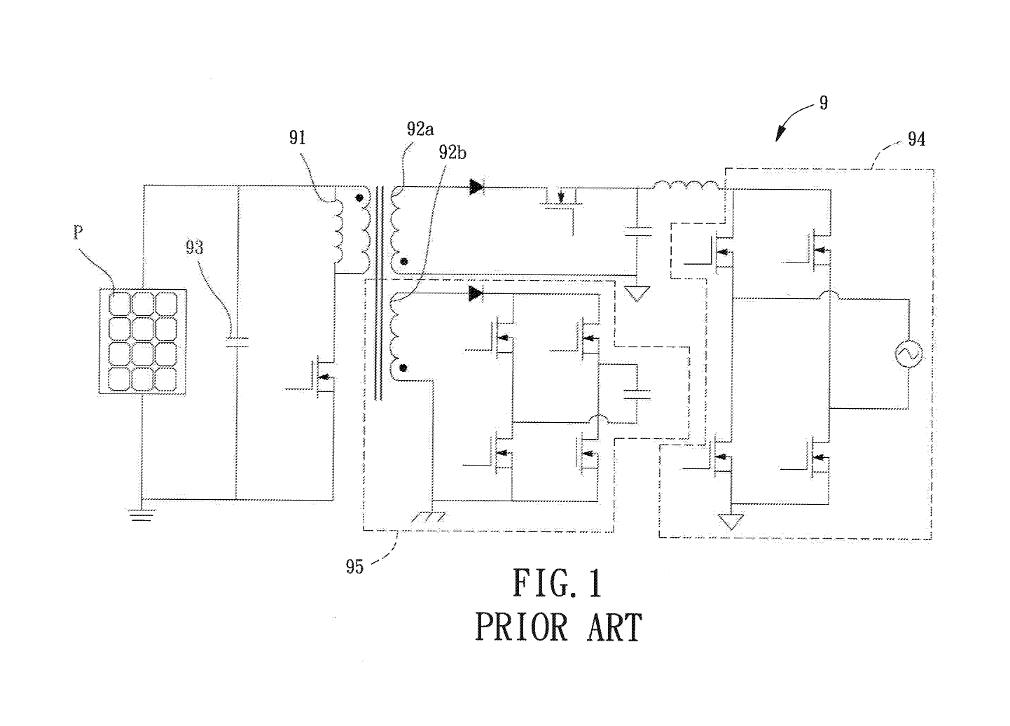

FIG. 2 shows a circuit diagram of a photovoltaic inverter according to a preferred embodiment of the invention.

FIG. 3a is a partial view of the photovoltaic inverter when the photovoltaic system is in operation.

FIG. 3b is another partial view of the photovoltaic inverter when the photovoltaic system is in operation.

FIG. 4 shows a flowchart of a control method of the photovoltaic inverter according to the preferred embodiment of the invention.

FIG. 5 shows operational information of the photovoltaic inverter of the preferred embodiment of the invention.

FIG. 6 shows input and output powers of the photovoltaic inverter of the preferred embodiment of the invention.

FIG. 7 shows a connection diagram of a control device according to the preferred embodiment of the invention.

FIG. 8 shows an internal block diagram of the control device according to the preferred embodiment of the invention.

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

The term “decoupling” referred hereinafter represents an operation that reduces an undesired phenomenon between input and output ends of a photovoltaic inverter. The undesired phenomenon may include, for example, a large ripple current that exists at the input end of the photovoltaic inverter due to the fact that the output power of the photovoltaic inverter has a frequency that is twice as high as the frequency of an output power of the terminal power system, as it can be readily appreciated by one having ordinary skill in the art.

The term “unidirectional element” referred hereinafter represents an element that allows current to flow therethrough in only one direction, such as a diode or the like. The unidirectional element includes a first end and a second end in which the current is allowed to flow only from the first end to the second end, as it can be readily appreciated by one having ordinary skill in the art.

The term “switch” referred hereinafter represents an element with electrically switching function, such as a metal-oxide-semiconductor field-effect transistor (MOSFET), a junction field-effect transistor (JFET), a bipolar transistor (BUT), etc. Each said component includes an input end, an output end and a control end. The control end may receive an electrical signal (such as a PWM signal) to control the ON/OFF function between the input and output ends, as it can be readily appreciated by one having ordinary skill in the art.

The term “MOSFET” referred hereinafter represents a transistor that is made of metal, oxide and semiconductor and includes PMOS and NMOS transistors. Each type of the transistors includes a source, a drain and a gate, as it can be readily appreciated by one having ordinary skill in the art.

The term “pulse width modulation (PWM)” referred hereinafter represents a mechanism which uses a pulse signal (consisting of logic high “1” and logic low “0” signals in each period of signal) to control the ON/OFF function of an electronic switch, as it can be readily appreciated by one having ordinary skill in the art.

The term “envelope” referred hereinafter represents an outline of the variation in the amplitude of an observed waveform, as it can be readily appreciated by one having ordinary skill in the art.

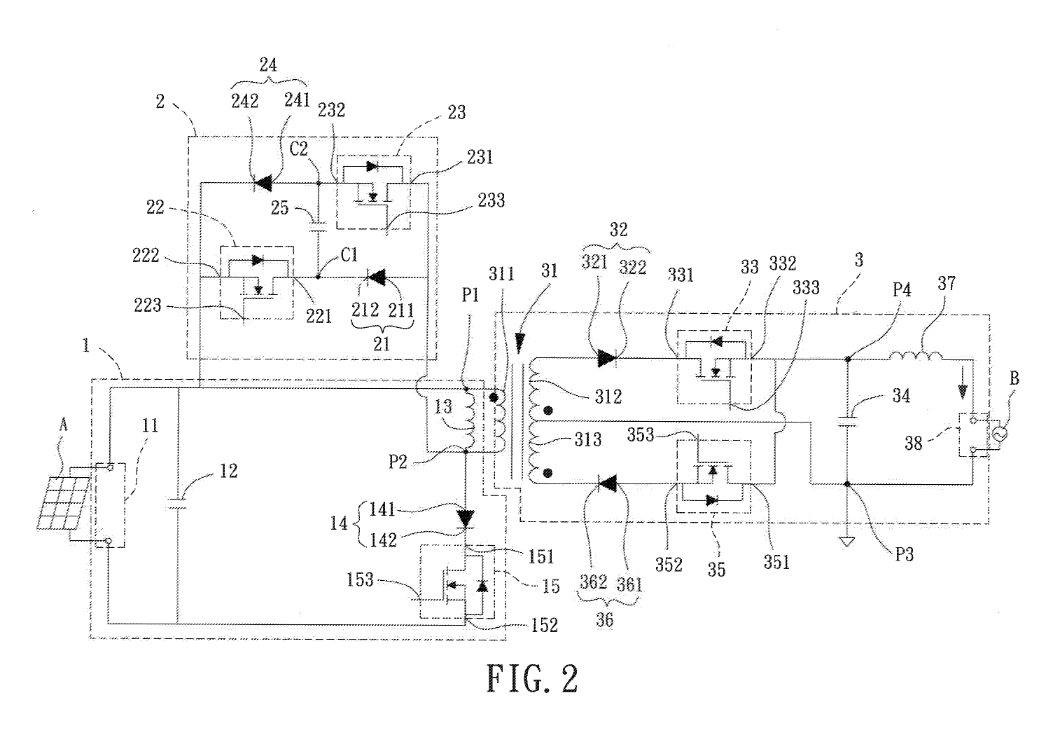

Referring to FIG. 2, a circuit diagram of a photovoltaic inverter is disclosed according to a preferred embodiment of the invention. The photovoltaic inverter includes an input circuit 1, a decoupling circuit 2 and an output circuit 3. The input circuit 1 is electrically connected to the decoupling circuit and the output circuit 3.

The input circuit 1 includes a DC input port 11, an input capacitor 12 connected to the DC input port 11 in parallel, a magnetizing inductor 13 connected to the input capacitor 12 in series, a first unidirectional element 14 and a first switch 15. The magnetizing inductor 13 has two ends forming a first connection node P1 and a second connection node P2. In this embodiment, the DC input port 11 is implemented as having two ends, the first unidirectional element 14 is implemented with a diode, and the first switch 15 is implemented with a transistor (such as a MOSFET or the like). However, the implementations of said components are not limited thereto.

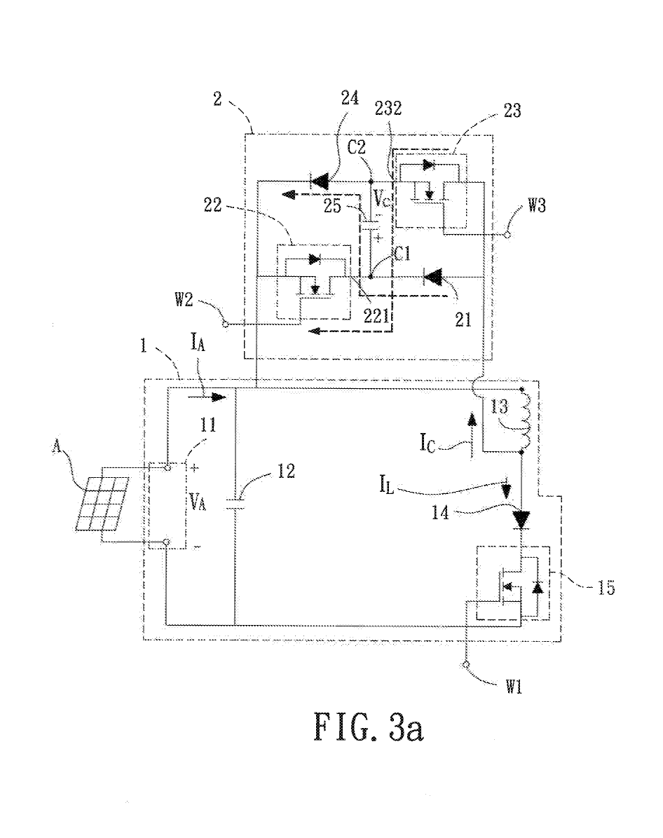

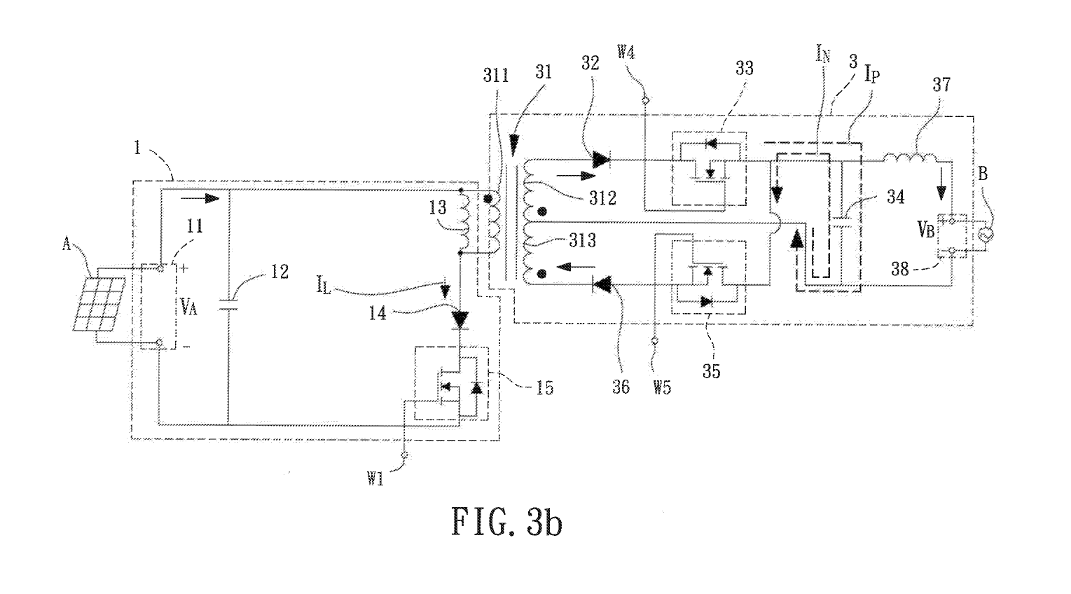

The DC input port 11 includes first and second ends adapted to be electrically connected to a photovoltaic system A. The first and second ends of the DC input port 11 are also electrically connected to first and second ends of the input capacitor 12. The input capacitor 12 is preferably implemented with a film capacitor to ensure reliable operation of the input circuit 1. The first end of the input capacitor 12 is electrically connected to the first connection node P1. The second connection node P2 is electrically connected to an anode of the first unidirectional element 14, which has a cathode electrically connected to an input end 151 of the first switch 15 (such as a drain of an NMOS transistor or a source of a PMOS transistor). The first switch 15 has an output end 152 (such as a source of an NMOS transistor or a drain of a PMOS transistor) that serves as a ground end electrically connected to the second end of the input capacitor 12. The first switch 15 further includes a control end 153 (such as a gate of an NMOS or PMOS transistor) that can be fed with a first control signal W1 (such as a PWM signal), as shown in FIG. 3a. The first control signal W1 controls the ON/OFF function between the input end 151 and the output end 152. The input capacitor 12 may have a capacitance of 40 μF. The magnetizing inductor 13 may have an inductance of 22 μH. These values provide reliable operation of the input circuit 1. However, the values of the input capacitor 12 and the magnetizing inductor 13 are not limited thereto.

Referring to FIG. 2 again, the decoupling circuit 2 includes a second unidirectional element 21, a second switch 22, a third switch 23, a third unidirectional element 24 and a decoupling capacitor 25. The second unidirectional element 21 and the second switch 22 are connected in series between the first connection node P1 and the second connection node P2. The node where the second unidirectional element 21 is connected to the second switch 22 forms a first node C1. The third switch 23 and the third unidirectional element 24 are also connected in series between the first connection node P1 and the second connection node P2. The node where the third switch 23 is connected to the third unidirectional element 24 forms a second node C2. The decoupling capacitor 25 is connected between the first node C1 and the second node C2. In this embodiment, the second unidirectional element 21 and the third unidirectional element 24 may be implemented with general diodes, and the decoupling capacitor 25 may be implemented with a general capacitor (such as a film capacitor or the like). However, the implementations of said components are not limited thereto.

The second unidirectional element 21 includes an anode 211 electrically connected to the second connection node P2 and an input end 231 of the third switch 23, as well as a cathode 212 electrically connected to an input end 221 of the second switch 22 and a first end of the decoupling capacitor 25. The third unidirectional element 24 includes an anode 241 electrically connected to a second end of the decoupling capacitor 25 and an output end 232 of the third switch 23, as well as a cathode 242 electrically connected to an output end 222 of the second switch 22 and the first connection node P1. The second switch 22 further includes a control end 223 that can be fed with a second control signal W2 (as shown in FIG. 3a) to control the ON/OFF function between the input end 221 and the output end 222. The third switch 23 further includes a control end 233 that can be fed with a third control signal W3 (as shown in FIG. 3a) to control the ON/OFF function between the input end 231 and the output end 232. The decoupling capacitor 25 may be preferably implemented with a film capacitor to improve the operational reliability of the decoupling circuit 2. The decoupling capacitor 25 preferably has a capacitance of 60 μF to achieve a balance between the ripple effect and the voltage stress of said switches.

Refer ing to FIG. 2 again, the output circuit 3 includes a transformer 31, a fourth unidirectional element 32, a fourth switch 33, an output capacitor 34, a fifth switch 35, a fifth unidirectional element 36, an output inductor 37 and an AC output port 38. The transformer 31 includes an input port 311, a first output port 312 and a second output port 313. The input port 311 is electrically connected to the magnetizing inductor 13 in parallel. The first output port 312 is electrically connected to the second output port 313 in series. The first output port 312 is further electrically connected to the fourth unidirectional element 32, the fourth switch 33 and the output capacitor 34 in series. The second output port 313 is electrically connected to the output capacitor 34, the fifth switch 35 and the fifth unidirectional element 36 in series. The output capacitor 34 is electrically connected to the output inductor 37 and the AC output port 38 in series. In the embodiment, the transformer 31 is implemented with a conventional center-tapped transformer, the fourth unidirectional element 32 and the fifth unidirectional element 36 are implemented with general diodes, the output capacitor 34 is implemented with a general capacitor, the output inductor 37 is implemented with a general inductor, and the AC output port 38 is implemented with two ends. However, the implementations of said components are not limited thereto.

The input port 311 includes first and second ends that are electrically connected to the first connection node P1 and the second connection node P2, respectively. Both the first output port 312 and the second output port 313 include first and second ends. The first ends of the first output port 312 and the second output port 313 are electrically connected together as a common node P3. The second end of the first output port 312 is electrically connected to an anode 321 of the fourth unidirectional element 32. The fourth unidirectional element 32 includes a cathode 322 electrically connected to an input end 331 of the fourth switch 33. The fourth switch 33 includes an output end 332 that is electrically connected to an input end 351 of the fifth switch 35 as a linking node P4. The fifth switch 35 includes an output end 352 electrically connected to an anode 361 of the fifth unidirectional element 36. The fifth unidirectional element 36 includes a cathode 362 electrically connected to the second end of the second output port 313. The output capacitor 34 includes first and second ends that are electrically connected to the common node P3 and the linking node P4, respectively. The output inductor 37 and the AC output port 38 are electrically connected in series between the first and second ends of the output capacitor 34, allowing the AC output port 38 to supply AC power to a terminal power system B. The fourth switch 33 may have a control end 333 that can be fed with a fourth control signal W4 (as shown in FIG. 3b) to control the ON/OFF function between the input end 331 and the output end 332. The fifth switch 35 may have a control end 353 that can be fed with a fifth control signal W5 (as shown in FIG. 3b) to control the ON/OFF function between the input end 351 and the output end 352. The output capacitor 34 may have a capacitance of 2.2 μF. The output inductor 37 may have an inductance of 320 μH.

FIGS. 3a and 3b show the photovoltaic inverter when the photovoltaic system is in operation. During the operation of the photovoltaic system, a control device (not shown) may be provided to obtain operational information of the input circuit 1, the decoupling circuit 2, the photovoltaic system A and the terminal power system B. The operational information may include, as an example, the magnitude of the excitation current I_{L} that flows out of the magnetizing inductor 13, the magnitude of the decoupling current I_{C} that flows into the decoupling circuit 2, the magnitude of the photovoltaic voltage V_{A} of the photovoltaic system A, the magnitude of the photovoltaic current I_{A} of the photovoltaic system A, and the magnitude of the output voltage V_{B} of the terminal power system B. Based on the information, the control device generates the first control signal W1, the second control signal W2, the third control signal W3, the fourth control signal W4 and the fifth control signal W5, so as to control the ON/OFF function of the first switch 15, the second switch 22, the third switch 23, the fourth switch 33 and the fifth switch 35. This ensures the normal operation of the photovoltaic inverter.

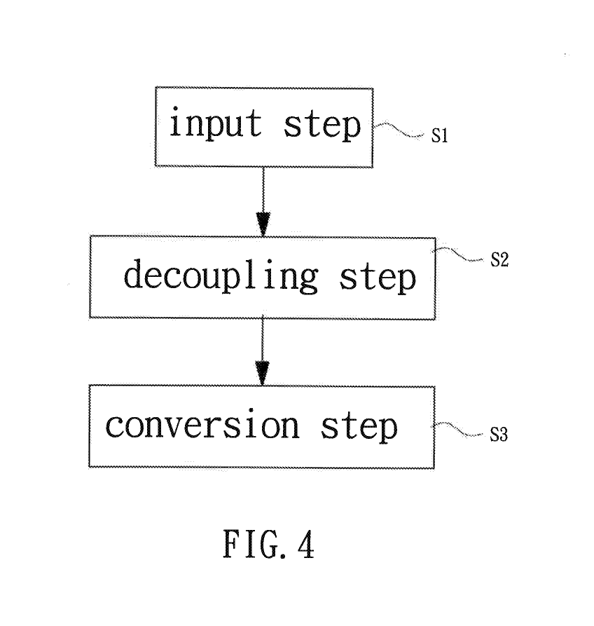

FIG. 4 shows a flowchart of a control method of the photovoltaic inverter according to the preferred embodiment of the invention. The control method includes an input step S1, a decoupling step S2 and a conversion step S3.

The input step S1 is adapted to turn on the first switch 15 and to turn off the second switch 22, the third switch 23, the fourth switch 33 and the fifth switch 35. This allows the magnetizing inductor 13 to store the energy delivered from the DC input port 11. Specifically, as shown in FIG. 3a, the photovoltaic system A may provide power to the input capacitor 12 and the magnetizing inductor 13 via the DC input port 11, so as to store the DC power supplied from the photovoltaic system A.

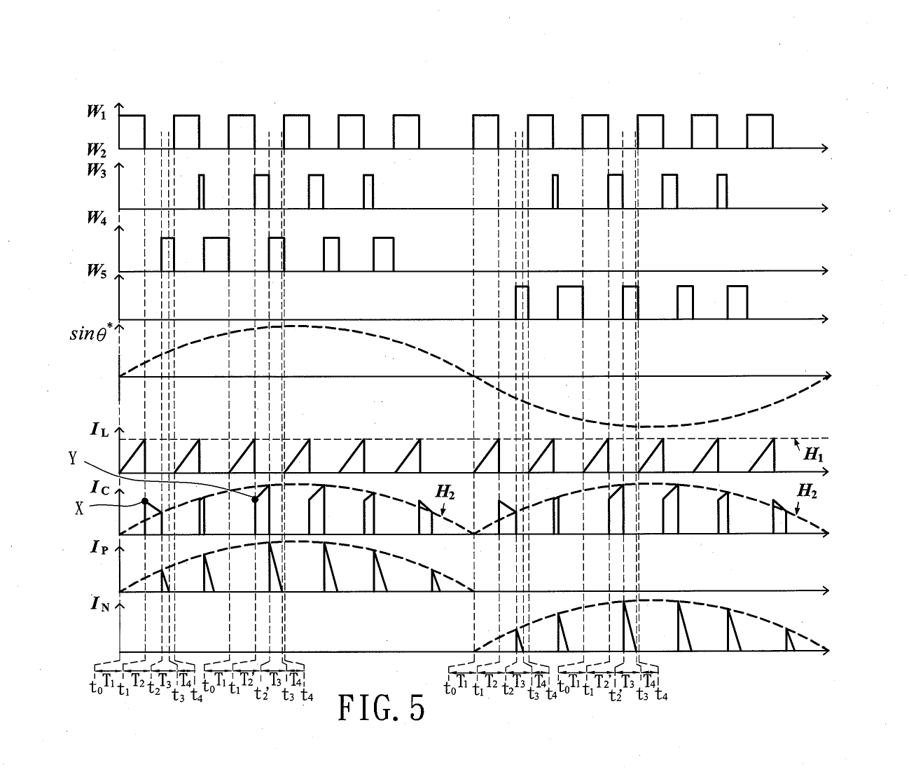

Referring to FIG. 5 also, when t=t₀, only the first switch 15 is turned on (by the first control signal W1). At this time, the magnetizing inductor 13, the first unidirectional element 14, the first switch 15 and the input capacitor 12 are connected in series to form a charging/discharging loop. In this regard, the photovoltaic system A, the input capacitor 12 and the magnetizing inductor 13 will finally have the same voltage level after the photovoltaic system A keep discharging power to the magnetizing inductor 13 for a duration of time T₁ (from t₀ to t₁). During the period of time T₁, the magnitude of the excitation current I_{L} is equal to that of the photovoltaic current I_{A}, as expressed by the following formula:

$${I}_{13} ( t ) = {I}_{in} ( t ) = \frac{{V}_{in}}{{L}_{13}} ( t - {t}_{0} ) , \qquad ( 1 )$$

In the above formula (1), I₁₃(t) represents a time-varying function of the excitation current I_{L}, Iᵢₙ(t) represents a time-varying function of the photovoltaic current I_{A}, Vᵢₙ represents a voltage value of the photovoltaic voltage V_{A}, and L₁₃ represents an inductance of the magnetizing inductor 13.

When t=t₁, the value of the excitation current I_{L} will reach an excitation threshold H1, as expressed by the following formula:

$$H 1 = {I}_{13} ( {t}_{1} ) = \frac{{V}_{in}}{{L}_{13}} ( {t}_{1} - {t}_{0} ) = \frac{{V}_{in}}{{L}_{13}} {D}_{1} {T}_{s} , \qquad ( 2 )$$

In the above formula (2), Tₛ represents a switching cycle of all the switches, and D₁ represents a duty cycle of the first switch 15. Since the excitation threshold H1 remains a constant value under a constant maximum power current command of the photovoltaic system A and since the switching frequency of the first to fifth switches is much higher than a maximum power tracking frequency of the photovoltaic system A, the photovoltaic voltage V_{A} is able to remain a constant value, as expressed in the following formula:

$${I}_{in} = \frac{{D}_{1} \cdot H 1}{2} = ( H 1 \cdot \frac{{L}_{13}}{{V}_{in} \cdot {T}_{s}} ) \frac{H 1}{2} = \frac{{L}_{13} \cdot H {1}^{2}}{2 \cdot {V}_{in} \cdot {T}_{s}} , \qquad ( 3 )$$

The decoupling step S2 is adapted to turn off the first switch 15 when the excitation current I_{L} has reached the excitation threshold H1. The decoupling step S2 is adapted to further turn off the second switch 22 and the third switch 23 when the decoupling current I_{C} is larger than a decoupling threshold H2, allowing the magnetizing inductor 13 to discharge energy to the decoupling capacitor 25. On the contrary, the decoupling step S2 turns on the second switch 22 and the third switch 23 when the decoupling current I_{C} is smaller than the decoupling threshold H2, allowing the decoupling capacitor 25 to discharge energy to the magnetizing inductor 13. The excitation threshold H1 may be obtained from the above formula (3), as expressed in the following formula (4);

$$H 1 = \sqrt{\frac{2 \cdot {V}_{in} \cdot {I}_{in} \times {T}_{s}}{{L}_{13}}} = \sqrt{\frac{2 V \cdot 250 A \times 50 μ s}{22 μ H}} = 33.71 A , \qquad ( 4 )$$

Referring to FIGS. 3a and 5, when t=t₁, the excitation current I_{L} has reached the excitation threshold H1. At this moment, the first switch 15 is switched off by the first control signal W1, and all other switches are accordingly switched off. At this time, the control device observes the decoupling current I_{C} that flows from the magnetizing inductor 13 into the decoupling circuit 2. If the decoupling current I_{C} is larger than the decoupling threshold H2 (H2 is an absolute value of the envelope “sin θ*” of the voltage V_{B}), it indicates that the magnetizing inductor 13 has too much energy that will cause the ripple current. Namely, the magnetizing inductor 13 has stored an extra amount of energy in addition to the required amount of energy, and the extra energy amount will cause an unwanted ripple current. In light of this, the control device controls the second switch 22 and the third switch 23 to remain off. At this point, the second unidirectional element 21, the decoupling capacitor 25 and the third unidirectional element 24 jointly form a charging path. Based on this, the extra energy of the magnetizing inductor 13 that causes the ripple current can be stored in the decoupling capacitor 25. Namely, the decoupling capacitor 25 is charged with the extra energy for a period of time T₂ (from t₁ to t₂), as expressed in the following formula (5):

$${t}_{2} - {t}_{1} = {D}_{2} {T}_{s} = \frac{{L}_{13} ( H 1 - H 2 )}{{V}_{25}} , \qquad ( 5 )$$

In the above formula (5), D₂ represents the duty cycle of the second unidirectional element 21 and the third unidirectional element 24, and V₂₅ represents the voltage value of the decoupling capacitor 25. During the period of time T₂, the voltage of the decoupling capacitor 25 remains a constant value. The decoupling current I_{C} may be expressed in the following formula:

$${I}_{25} ( t ) = H 1 - \frac{{V}_{25}}{{L}_{13}} ( t - {t}_{1} ) , \qquad ( 6 )$$

In the above formula (6), I₂₅(t) represents a time-varying function of the decoupling current I_{C}. When the decoupling current I_{C} has reduced to the decoupling threshold H2 (this happens when t=t₂), V₂₅(t) is a time-varying function of the voltage of the decoupling capacitor 25.

Furthermore, if the decoupling current I_{C} is smaller than the decoupling threshold H2 at t=t₁ (as shown by node Y in FIG. 5), it indicates that the magnetizing inductor 13 has insufficient energy which also causes the ripple current. In this regard, only the second switch 22 and the third switch 23 are turned on, allowing the third switch 23, the decoupling capacitor 25 and the second switch 22 to form a discharging path. Based on this, the extra energy that has been previously stored in the decoupling capacitor 25 may be discharged to the magnetizing inductor 13. The current that flows from the decoupling capacitor 25 to the magnetizing inductor 13 may be expressed by the above formula (6) to make up the energy difference required by the magnetizing inductor 13. The decoupling capacitor 25 discharges energy to the magnetizing inductor 13 for a period of time T₂′ (from t₁ to t₂′), as expressed in the following formula (7):

$${t}_{2}^{′} - {t}_{1} = {D}_{2}^{′} {T}_{s} = \frac{{L}_{13} ( H 1 - H 2 )}{{V}_{25}} , \qquad ( 7 )$$

In the above formula (7), D₂′ represents a duty cycle of the second switch 22 and the third switch 23.

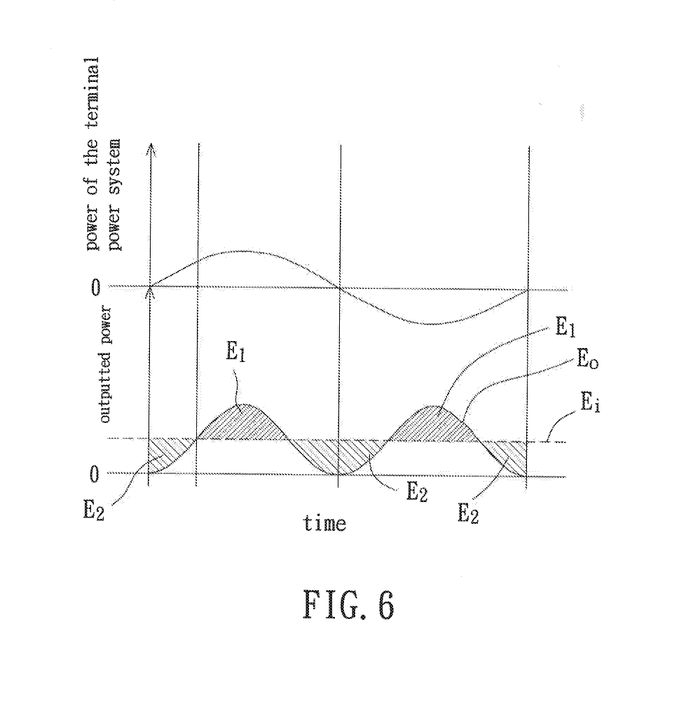

FIG. 6 shows the input and output powers during the period of time T₂ (from t₁ to t₂). In FIG. 6, the input power Eᵢ is compared with the output power Eₒ whose frequency is twice as high as the input power Eₒ, and it indicates that the extra energy E₁ of the output AC power Eₒ may be temporarily stored in the decoupling capacitor 25. Based on this, the stored energy can be used to make up the part of energy E₂ for the period of time T₂′ (from t₁ to t₂′). In this manner, the magnitude of the decoupling current I_{C} will be equal to that of the decoupling threshold H2 based on the charging/discharging operations of the decoupling capacitor 25. This prevents an excessive amount of energy from being resulted as well as preventing shortage in energy, thereby providing a stable output power. Advantageously, the required capacitance of the input capacitor 12 can be significantly lowered, allowing the input capacitor 12 to be replaced with a film capacitor that is highly heat-resistant. Consequently, the photovoltaic inverter will have stable operation.

In the conversion step S3, if the voltage V_{B} is in a positive cycle when the decoupling current I_{C} is equal to the decoupling threshold H2, the fourth switch 33 is turned on and the fifth switch 35 is turned off to allow the first output port 312 to release energy to the output capacitor 34. In the other case scenario, if the voltage V_{B} is in a negative cycle, the fifth switch 35 is turned on and the fourth switch 33 is turned off to allow the second output port 313 to release energy to the output capacitor 34. Specifically, as shown in FIGS. 3b and 5, the transformer 31 may output different cycles of AC power to the output capacitor 34 via the first output port 312 and the second output port 313 of the transformer 31. In this phase, if the envelope “sin θ*” of the voltage V_{B} is in the positive cycle, the fourth switch 33 is turned on by the fourth control signal W4 and the fifth switch 35 is turned off by the fifth control signal W5. At this time, the first output port 312, the fourth unidirectional element 32, the fourth switch 33 and the output capacitor 34 may form another charging/discharging loop to allow the first output port 312 to release energy to the output capacitor 34 for a period of time T₂ (from t₂ to t₃), as expressed in the following formula (8):

$${t}_{3} - {t}_{2} = {t}_{3} - {t}_{2}^{′} = {D}_{3} {T}_{s} = N \cdot H 1 \frac{{L}_{13}}{{v}_{B}} , \qquad ( 8 )$$

In the above formula (8), D₃ represents a duty cycle in which the energy of the magnetizing inductor 13 can be completely discharged, N represents the turn ratio of the transformer 31 being the ratio of the number of turns of wire on the secondary side of the transformer 31 to the number of turns of wire on the primary side of the transformer 31, and νₙ represents the envelope of the voltage V_{B} (the envelope is expressed as ν_{B}=V_{B,peak}|sin ωt|). The current I_{P} that flows from the first output port 312 to the output capacitor 34 is expressed in the following formula (9):

$${I}_{P} ( t ) = \frac{1}{N} \cdot H 2 - \frac{{v}_{B}}{{N}^{2} \cdot {L}_{13}} ( t - {t}_{2} ) , \qquad ( 9 )$$

Moreover, if the envelope “sin θ*” of the voltage V_{B} is in a negative cycle, the fifth switch 35 is turned on by the fifth control signal W5 and the fourth switch 33 is turned off by the fourth control signal W4, allowing the second output port 313, the output capacitor 34, the fourth switch 33 and the fourth unidirectional element 32 to form another charging/discharging loop. The current I_{N} may flow into the output capacitor 34, as expressed in the following formula (10):

$${I}_{N} ( t ) = - [ \frac{1}{N} \cdot H 2 - \frac{{v}_{B}}{{N}^{2} \cdot {L}_{13}} ( t - {t}_{2} ) ] , \qquad ( 10 )$$

Specifically, when the fourth switch 33 or the fifth switch 35 is turned off, the first to fifth switches are turned off by the control signals W1 to W5 to allow the output capacitor 34 to discharge energy to the AC output port 38 via the output inductor 37 for a period of time T₄ (from t₃ to t₄). At this time, the magnetizing inductor 13 has no more energy to be transferred to the terminal power system B via the AC output port 38. The fourth switch 33 and the fifth switch 35 can be repeatedly switched and the energy outputted by the first output port 312 and the second output port 313 can be filtered by the output capacitor 34 and the output inductor 37, thereby finally outputting an AC voltage to the terminal power system B.

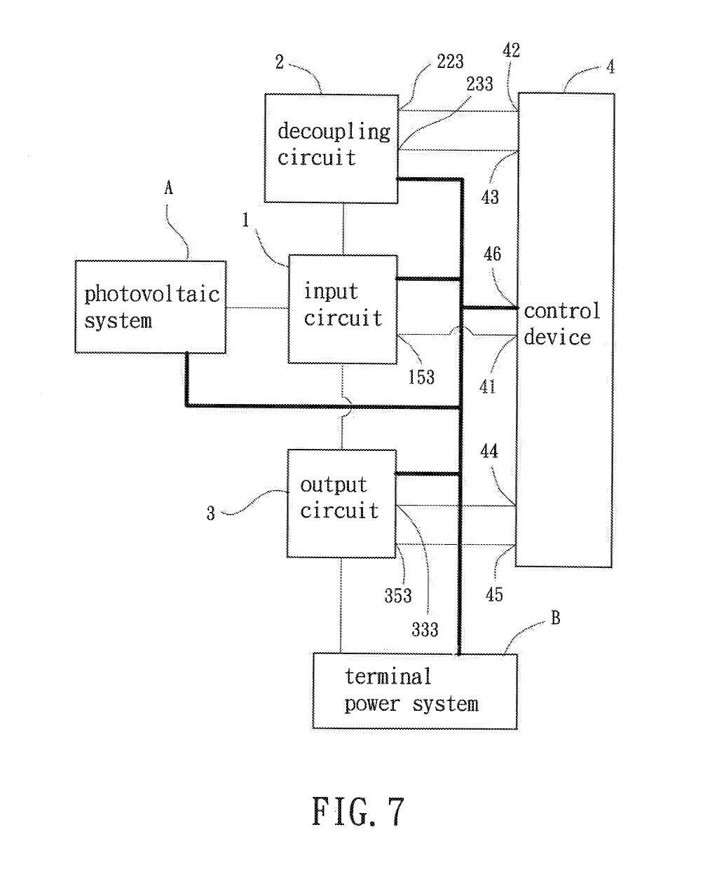

FIG. 7 shows a connection diagram of the control device according to the preferred embodiment of the invention. In FIG. 7, the control device discussed previously is numbered as 4. The control device may be an electronic circuit or a programmable pulse generator capable of controlling the ON/OFF function of the first switch 15, the second switch 22, the third switch 23, the fourth switch 33 and the fifth switch 35 based on the operational information of the photovoltaic system A, the terminal power system B, the input circuit 1 and the decoupling circuit 2. The operational information may include the magnitudes of the excitation current I_{L}, the decoupling current I_{C}, a voltage V_{C} of the decoupling capacitor 25, the photovoltaic voltage V_{A} and the photovoltaic current I_{A} of the photovoltaic system A, and the voltage V_{B} of the terminal power system B. In this embodiment, the control device 4 includes a first output end 41, a second output end 42, a third output end 43, a fourth output end 44 and a fifth output end 45. The first output end 41 is electrically connected to the control end 153 of the first switch 15, the second output end 42 is electrically connected to the control end 223 of the second switch 22, the third output end 43 is electrically connected to the control end 233 of the third switch 23, the fourth output end 44 is electrically connected to the control end 333 of the fourth switch 33, and the fifth output end 45 is electrically connected to the control end 353 of the fifth switch 35. The first output end 41 outputs the first control signal W1, the second output end 42 outputs the second control signal W2, the third output end 43 outputs the third control signal W3, the fourth output end 44 outputs the fourth control signal W4, and the fifth output end 45 outputs the fifth control signal W5. The control device 4 further includes an input bus 46 electrically connected to the photovoltaic system A, the terminal power system B, the input circuit 1 and the decoupling circuit 2 to obtain the aforementioned operational information, so that the control signals W1 to W5 can be generated.

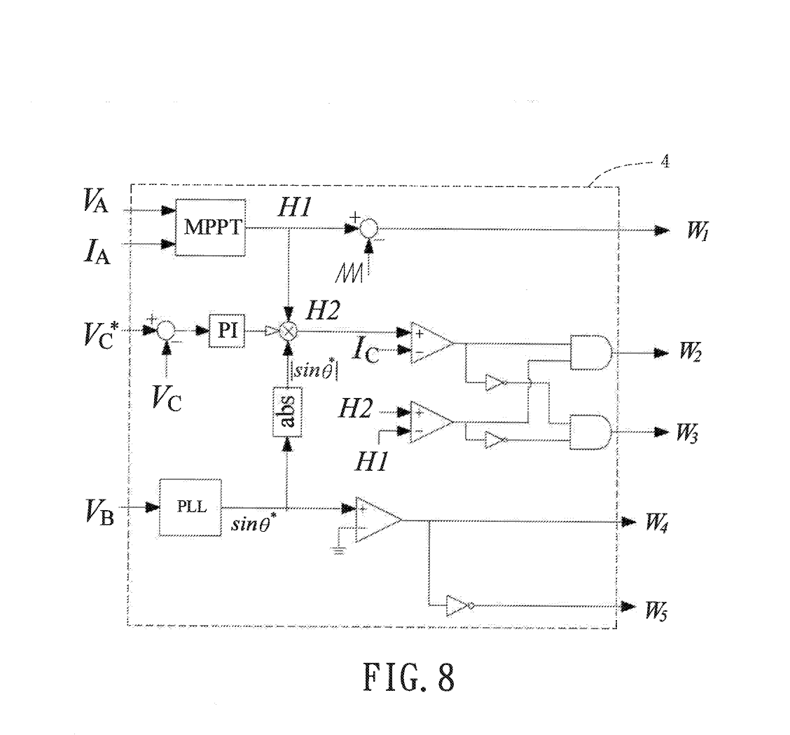

As an example, referring to FIG. 8, an internal block diagram of the control device 4 is shown according to the preferred embodiment of the invention. The control device 4 includes a maximum power point tracker (MPPT), a proportional integral controller (PI), a phase lock loop (PLL), an absolute-value generator (ABS), a plurality of subtractors (SUB), a multiplier (MUL), a plurality of comparators (CMP), a plurality of inverters (INV) and a plurality of logic gates (AND). The power tracker is able to generate an excitation threshold H1 based on the values of the photovoltaic voltage V_{A} and the photovoltaic current I_{A}. The excitation threshold H1 is compared with a software-generated sawtooth wave to generate the first control signal W1. The phase lock loop generates the envelope of the voltage V_{B} (i.e. the function “sin θ*” as shown in FIGS. 5 and 8), such that the absolute-value generator generates an absolute value of the envelope (i.e. the function “|sin θ*” as shown in FIG. 8). The voltage V_{C} has a target value V_{C}*, and a subtraction is performed between the voltage V_{C} and its target value V_{C}* to obtain a difference value. The difference is amplified by the proportional integral controller to obtain an error value. The multiplier multiples the error value by the absolute value of the envelope and the excitation threshold H1 to obtain a decoupling threshold H2. The value of the decoupling current I_{C} is subtracted from the decoupling threshold 112 to obtain a first result. The excitation threshold H1 is subtracted from the decoupling threshold H2 to obtain a second result. Then, an AND operation is performed between the first and second results to generate the second control signal W2 and the third control signal W3. The value of the envelope is compared with zero, and the part of the envelope that is larger than zero may be used to generate the fourth control signal W4. The fourth control signal W4 is inverted to obtain a signal whose value is smaller than zero. The signal is used as the fifth control signal W5.

Based on the technique concept above, the photovoltaic inverter has a variety of features. First, the magnetizing inductor 13, the first unidirectional element 14, the first switch 15 and the input capacitor 12 are connected in series to form a charging/discharging loop of the input circuit 1. Second, the second unidirectional element 21, the decoupling capacitor 25 and the third unidirectional element 24 jointly form the charging loop of the input circuit 1 while the third switch 23, the decoupling capacitor 25 and the second switch 22 jointly form the discharging loop of the input circuit 1. Third, the first output port 312, the fourth unidirectional element 32, the fourth switch 33 and the output capacitor 34 jointly form another charging/discharging loop. Alternatively, the second output port 313, the output capacitor 34, the fourth switch 33 and the fourth unidirectional element 32 jointly form another charging/discharging loop. Advantageously, electrical decoupling can be performed using only five switches. As compared with a conventional photovoltaic inverter with the same function, the invention significantly reduces the number of switches required.

In the above mechanism, the decoupling capacitor 25 is able to store the extra energy via the charging loop before DC power is converted into AC power, and the stored energy can be discharged to the magnetizing inductor 13 via the discharging loop to make up the required energy of the AC power. As a result, a stable output power is generated, reducing the voltage stresses of the electronic switches. In another aspect, the required capacitance of the input capacitor 12 can be lowered and the input capacitor 12 can be replaced with a film capacitor with excellent heat resistibility, ensuring the stable operation of the photovoltaic inverter.

Moreover, assume the photovoltaic system A is implemented with a solar panel having a rated power of 250 W (namely the photovoltaic inverter operates at 250 W); based on this, although the watt of the photovoltaic system A is increased, the photovoltaic system A can still operate normally without increasing the capacitance and rated voltage of the decoupling capacitor 25.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A photovoltaic inverter comprising:
an input circuit having a direct current (DC) input port, an input capacitor, a magnetizing inductor, a first unidirectional element and a first switch, wherein the DC input port is connected to the input capacitor in parallel, wherein the input capacitor is connected to the magnetizing inductor, the first unidirectional element and the first switch in series, and wherein the magnetizing inductor has two ends forming a first connection node and a second connection node;
a decoupling circuit having a second unidirectional element, a second switch, a third switch, a third unidirectional element and a decoupling capacitor, wherein the second unidirectional element and the second switch are connected in series at a first node and connected between the first connection node and the second connection node, wherein the third switch and the third unidirectional element are connected in series at a second node and connected between the first connection node and the second connection node, and wherein the decoupling capacitor is connected between the first and second nodes; and
an output circuit having a transformer, a fourth unidirectional element, a fourth switch, an output capacitor, a fifth switch, a fifth unidirectional element, an output inductor and an alternating current (AC) output port, wherein the transformer comprises an input port, a first output port and a second output port, wherein the input port is electrically connected to the magnetizing inductor in parallel, wherein the first output port is electrically connected to the second output port in series, wherein the first output port is electrically connected to the fourth unidirectional element, the fourth switch and the output capacitor in series, wherein the second output port is electrically connected to the output capacitor, the fifth switch and the fifth unidirectional element in series, and wherein the output capacitor is electrically connected to the output inductor and the AC output port in series.

2. The photovoltaic inverter as claimed in claim 1, wherein the second unidirectional element comprises an anode electrically connected to the second connection node and an input end of the third switch, wherein the second unidirectional element further comprises a cathode electrically connected to an input end of the second switch and a first end of the decoupling capacitor, wherein the third unidirectional element comprises an anode electrically connected to a second end of the decoupling capacitor and an output end of the third switch, and wherein the third unidirectional element further comprises a cathode electrically connected to an output end of the second switch and the first connection node.

3. The photovoltaic inverter as claimed in claim 1, wherein the decoupling capacitor is a film capacitor.

4. The photovoltaic inverter as claimed in claim 1, wherein the decoupling capacitor has a capacitance of 60 μF.

5. The photovoltaic inverter as claimed in claim 1, wherein the input port of the transformer comprises first and second ends electrically connected to the first and second connection nodes respectively, wherein both the first and second output ports comprise first and second ends, wherein the first ends of the first and second output ports are electrically connected together as a common node, wherein the second end of the first output port is electrically connected to an anode of the fourth unidirectional element, wherein the fourth unidirectional element further comprises a cathode electrically connected to an input end of the fourth switch, wherein the fourth switch further comprises an output end electrically connected to an input end of the fifth switch to form a linking node, wherein the fifth switch comprises an output end electrically connected to an anode of the fifth unidirectional element, wherein the fifth unidirectional element further comprises a cathode electrically connected to the second end of the second output port, wherein the output capacitor comprises first and second ends that are electrically connected to the common node and the linking node respectively, and wherein the output inductor and the AC output port are electrically connected in series between the first and second ends of the output capacitor.

6. The photovoltaic inverter as claimed in claim 1, wherein the DC input port comprises first and second ends electrically connected to first and second ends of the input capacitor, wherein the first end of the input capacitor is electrically connected to the first connection node, wherein the second connection node is electrically connected to an anode of the first unidirectional element, wherein the first unidirectional element further comprises a cathode electrically connected to an input end of the first switch, and wherein the first switch further comprises an output end electrically connected to the second end of the input capacitor.

7. The photovoltaic inverter as claimed in claim 1, wherein each of the first, second, third, fourth and fifth switches includes a transistor.

8. The photovoltaic inverter as claimed in claim 1, wherein each of the first, second, third, fourth and fifth unidirectional elements includes a diode.

9. The photovoltaic inverter as claimed in claim 1, further comprising a control device having a first output end, a second output end, a third output end, a fourth output end and a fifth output end, wherein the first output end is electrically connected to a control end of the first switch, wherein the second output end is electrically connected to a control end of the second switch, wherein the third output end is electrically connected to a control end of the third switch, wherein the fourth output end is electrically connected to a control end of the fourth switch, and wherein the fifth output end is electrically connected to a control end of the fifth switch.

10. A control method of the photovoltaic inverter as claimed in claim 1, wherein a control device is used to retrieve information regarding a magnitude of an excitation current flowing through the magnetizing inductor, a magnitude of a decoupling current flowing in the decoupling circuit, and a magnitude of an output voltage of a terminal power system, wherein the retrieved information is used to generate a first control signal, a second control signal, a third control signal, a fourth control signal and a fifth control signal for controlling the ON/OFF function of the first switch, the second switch, the third switch, the fourth switch and the fifth switch, and wherein the control method comprises:
an input step adapted to turn on the first switch and to turn off the second switch, the third switch, the fourth switch and the fifth switch, so as to allow the magnetizing inductor to store energy delivered from the DC input port;
a decoupling step adapted to turn off the first switch when the excitation current has reached an excitation threshold, wherein the decoupling step is further adapted to turn off the second switch and the third switch when the magnitude of the decoupling current is larger than a decoupling threshold, so as to allow the magnetizing inductor to release energy to the decoupling capacitor, and wherein the decoupling step is further adapted to turn on the second switch and the third switch when the magnitude of the decoupling current is smaller than the decoupling threshold, so as to allow the decoupling capacitor to discharge energy to the magnetizing inductor; and
a conversion step adapted to turn on the fourth switch and to turn off the fifth switch if the output voltage of the terminal power system is in a positive cycle when the decoupling current is equal to the decoupling threshold, so as to allow the first output port to release energy to the output capacitor, wherein the conversion step is further adapted to turn on the fifth switch and to turn off the fourth switch if the output voltage of the terminal power system is in a negative cycle, so as to allow the second output port to release energy to the output capacitor, and wherein energy is discharged from the output capacitor to the AC output port via the output inductor when the fourth switch or the fifth switch is turned off, thereby delivering AC power to the terminal power system.

11. The control method as claimed in claim 10, wherein the excitation threshold is 33.71 A.

12. The control method as claimed in claim 10, wherein the decoupling threshold is an envelope of the output voltage of the terminal power system.
